(19) United States
(12) Patent Application Publication
(10) Pub. No.: US 2005/0188322 A1
(43) Pub. Date: Aug. 25, 2005

(54) Method and apparatus for producing structured SGML/XML student compositions

(76) Inventor: Suzanne Napoleon, Ann Arbor, MI (US)

Correspondence Address: YOUNG & BASILE, P.C., 3001 WEST BIG BEAVER ROAD, SUITE 624, TROY, MI, 48084, US

(21) Appl. No.: 11/032,383

(22) Filed: Jan. 10, 2005

Related U.S. Application Data
(60) Provisional application No. 60/535,383, filed on Jan. 9, 2004.

(51) Int. Cl. G06F 3/00; G06F 17/00

(52) U.S. Cl. 715/760; 715/764; 715/513

(57) ABSTRACT

System and automated tools accessed from a variety of graphical user interfaces that students can personalize to enable them to author student compositions as structured documents using Standardized General Markup Language (SGML) and/or eXtensible Markup Language (XML) that may include tables, graphics, and equations, read educational material related to the compositions, link to approved internet sites related to the compositions, validate the contents of a structured document against applicable rules for the type of composition, automatically format and reformat structured documents and system-generated material, as appropriate for the type and style of composition into predefined, user-modifiable presentation styles appropriate for the type of student composition as selected by the user, and enjoy a better homework experience with computer-game-like sound effects and animation accompanying system dialogs and messages.

### CROSS REFERENCE TO CO-PENDING APPLICATION

This application claims the benefit of the priority filing date of U.S. Provisional Patent Application Ser. No. 60/535,383 filed Jan. 9, 2004, the contents of which are incorporated herein in its entirety.

### BACKGROUND

The present invention relates in general to the production of student compositions. Available word processing software products for personal computers have added new features over the years. Although these new features appear to increase product functionality, they have the negative effect of making the software more and more difficult to use, thereby limiting its actual use.

Available products rely more and more on artificial intelligence (AI), but manual intervention is still required because AI capabilities are not foolproof Compared to the real intelligence afforded by structured SGML and XML documents, AI comes up short. Structured documents are content-based whereas documents produced with available word processing software are based on the presentation format.

Content-based structured documents provide a variety of benefits over format-based documents including the ability to publish the same text in multiple presentation styles to all types of media and to reuse and interchange information without regard for presentation style.

A major problem for production of structured documents is document creation. Available tools for producing structured documents require significant training and specialized knowledge, both of which are inappropriate for the student age group. At the same time, conversion of documents authored in conventional word processors is a time-consuming and error-prone process that is also not appropriate for the student age group.

The present apparatus and method utilizes menu-free, point-and-click, user-chosen graphical user interfaces that can be personalized by users to make the advantages of structured documents easily accessible to students for their school compositions without special training or expert knowledge.

Some of the documents students write include any of the following:
Poetry: Haiku, Limerick, Sonnet;
Fiction: Short Story, School Play;
Reports: Book Report, Lab Report, General Report;
Non-Fiction: Essay;
Research: Term Paper, Research Paper, Thesis, Dissertation.

Student compositions such as these have specific requirements for structure and formatting. The “rules” are fairly simple for poems, but other documents, such as lab reports, have a lot more rules. Students encountering these documents for the first time are not familiar with the rules and naturally can use all the help they can get to adhere to the structure and formatting requirements.

Even older students experienced in writing student compositions can use help with research papers. Research papers have the most complex structural and formatting requirements which include font size, margins and indents as well as complex rules for bibliographic and citation information. The requirements vary according to the citation style used, which depends on the field of study and the requirements of the school and instructor.

There are many citation styles in use today. The “Big Three” citation style organizations publish their rules as follows:

American Psychological Association (APA) publishes a Publication Manual for use in the fields of psychology, sociology, business, economics, nursing, social work, and justice administration. To readily identify recent research, text citations show the author's surname and the year of publication.

Chicago/Turabian style publishes Manual for Writers of Term Papers, Theses, and Dissertations for use in the humanities, social sciences and natural sciences. In addition to text citations in the text, it allows footnotes and end notes, depending on the field of study.

Modern Languages Association (MLA) publishes a MLA Handbook for Writers of Research Papers for high school and undergraduate college students and a MLA Style Manual and Guide to Scholarly Publishing for graduate students, scholars, and professional writers. MLA style is used in humanities research. For text citations, to make quotations easy to find, text citations use the author's surname and the page number(s) in the cited work.

Some students need just one citation style during their academic careers, but others are not so lucky. A psychology professor may specify APA, a paper for a literature course may need MLA style, and the school may require Chicago/Turabian for theses and dissertations.

It is important to bear in mind that accurate citations make the difference between research and plagiarism, and many instructors deduct grade points for citation errors. Others have a less stringent policy, but student grades may still be adversely affected by citation errors. The comments of one English professor reveal the student's dilemma:

“There are professors out there who insist on letter-perfect papers before they'll even read them . . . I tell my students that I correct citation mechanics on papers, but don't factor such things into the grade. And I try to follow that, though I confess I don't always succeed. A paper that's sloppy in the citations will inevitably lower my opinion of the writer, and even if I try consciously to treat him or her fairly, the damage has been done. Conversely, a paper that's prepared to professional standards inevitably impresses me, and I might end up being more generous to it than to an equally good paper.”

Most students cannot afford to pay an expert to ensure their papers are prepared to professional standards. The present invention incorporates the expert knowledge into the software. Formatting requirements and rules for bibliographies and citations are built into the software so students can get the same professional results without the expense of hiring a professional to review their papers.

WO98/34179, U.S. Pat. No. 5,557,720 and U.S. Pat. No. 5,140,521 describe techniques for processing structured documents. In general, these patents relate to either altering a structured document or processing such documents to generate styled output for either display or printing.

Thus, it would be desirable to provide a process for students to use a variety of menu-free, point-and-click graphical user interfaces to easily, accurately, and efficiently produce student compositions as structured documents that may include tables, graphics, and equations.

It would also be desirable to provide students with the benefits of structured documents including:
consistent formatting appropriate for the type of student composition;
automatic system-generation of document contents such as text, numbering, graphics, symbols, spacing, punctuation, table of contents, list of tables, list of illustrations, citations, bibliography, list of references, list of works cited, and index as appropriate to the type of student composition;
the ability to change presentation style and associated system-generated material at any time; and
the ability to reuse portions of existing student compositions in new compositions without regard for presentation style or system-generated material.

It would also be desirable to help improve student grades by providing automated tools to validate structured document content against applicable rules for the type of student composition as well as links to approved Internet sites related to the types of student compositions.

Finally, it would be desirable to provide a better homework experience for students by delivering: consistently and correctly formatted documents in less time than needed with currently available tools; a user-friendly computer-game-like interface with sound effects and animation accompanying dialogs and messages; useful tools; and educational information about student compositions.

### SUMMARY

According to the invention, there is provided a document production process carried out by a system consisting of:
customized structured document software;
a set of predefined SGML/XML Document Types designed for student compositions each of which includes a Document Type Definition (DTD) that defines a document structure with required and optional SGML/XML elements and attributes suitable to the type of student composition; a variety of stylesheets supporting presentation styles suitable to the type of student composition; and other electronic files and scripts as needed to customize the Document Type for the type of student composition;
a variety of menu-free, point-and-click graphical user interfaces that include an authoring/editing window, a print preview display window; elements that can be used in each particular type of student composition; educational information about each type of student composition; automated tools to validate the composition content against the rules for the student composition; and Internet links appropriate to the type of student composition; and
optional computer-game-like sound effects and animation accompanying system dialogs and messages.

### BRIEF DESCRIPTION OF THE DRAWING

The various features, advantages and other uses of the present invention will become more apparent by referring to the following detailed description and drawing in which:

FIG. 1 is a flow diagram showing the structure and process of the invention;

FIG. 2 is one aspect of a personalized cockpit graphical user interface providing access to new and existing documents;

FIG. 3 is another aspect of a personalized cockpit graphical user interface with a book report document;

FIG. 4 is one aspect of a personalized cockpit graphical user interface with a research paper document;

FIG. 5 is one aspect of a playing field graphical user interface theme with an existing book report document;

FIG. 6 is one aspect of a football field graphical user interface with a book report document;

FIG. 7 is one aspect of a vanity table graphical user interface with an existing book report document;

FIG. 8 is one aspect of a vanity table graphical user interface with a book report document;

FIG. 9 is another aspect of a vanity table graphical user interface with a Haiku document;

FIG. 10 is a flow diagram illustrating how a click in the graphical user interface becomes a command in Epic Editor;

FIG. 11 is a flow diagram illustrating how a click in the graphical user interface activates the syllable counting tool;

FIG. 12 is a pictorial representation of a portion of the XML DTD for the Haiku document type;

FIG. 13 is a pictorial representation of a Haiku XML document as an ASCII file;

FIG. 14 is a pictorial representation of the formatted Haiku document shown in FIG. 13;

FIG. 15 is a graphical representation of the beginning of a research paper document showing the paragraph, cross-reference, figure, graphic, bibliography magician and equation tags:

FIG. 16 is a screen display showing the cross-reference dialog; and

FIG. 17 is a pictorial representation of the bibliography magician dialog.

### DETAILED DESCRIPTION

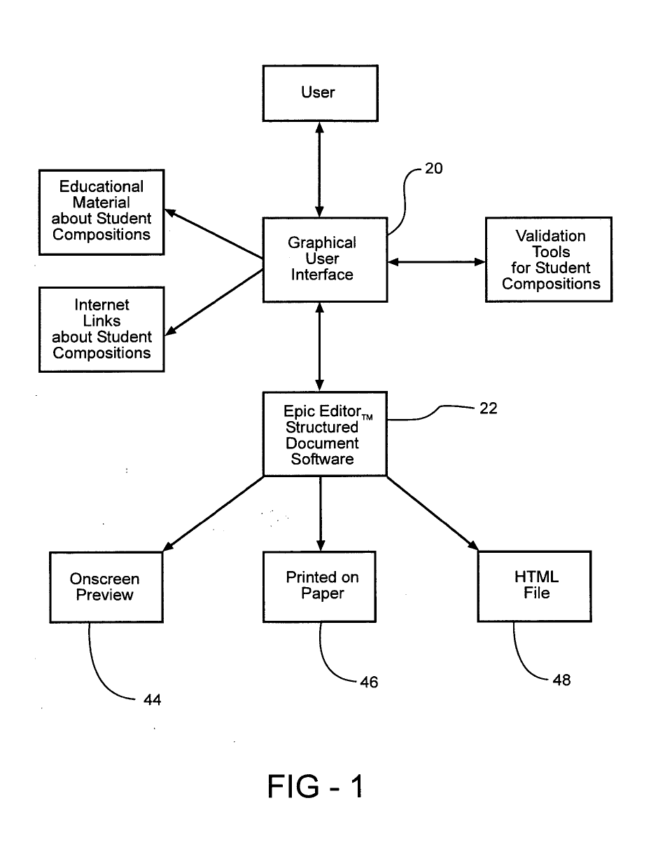

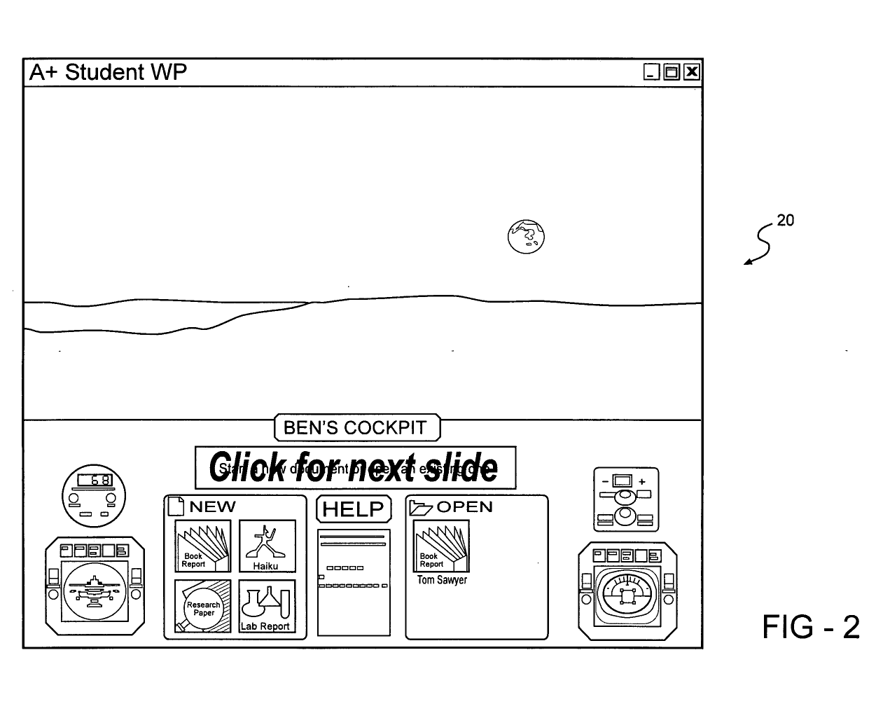

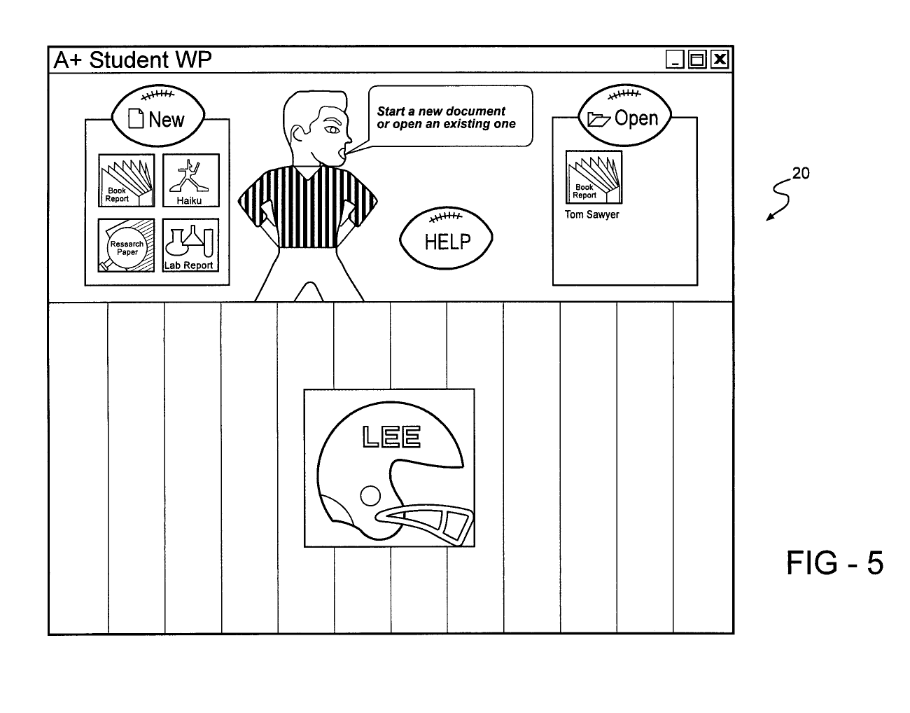

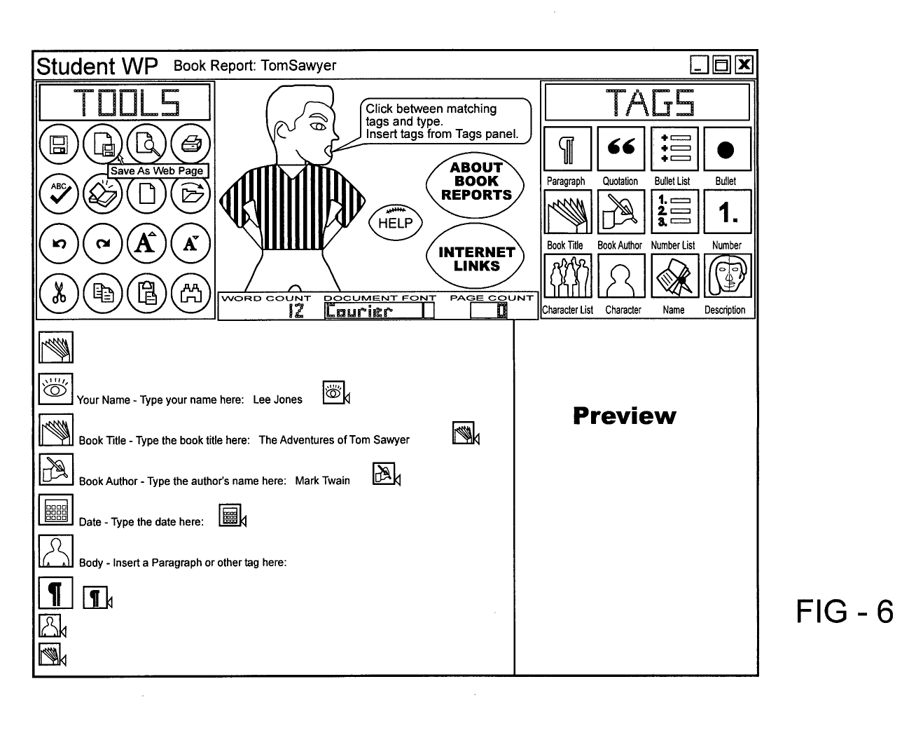

As shown periodically in FIG. 1, the present invention is a software program which can be loaded from a computer storage media, i.e., a CD, into a memory for execution by a processor, or downloaded from a telecommunication network and allows users to choose from a variety of graphical user interfaces 20 from a variety of themes including, but not limited to, cockpits (boat, plane, race car, motorcycle, space ship); desktops (student, office, doctor, lawyer, scientist, president); music (stereo controls, electronic music console, electronic keyboards); nature (beach bag, mountain climbing kit, fishing tackle box); playing field (baseball, basketball, football, hockey, soccer, tennis); vanity table (manicure set, makeup kit, jewelry box); each of which provides access to electronic files with existing structured documents 22 and the ability to create electronic files with new structured documents based on the type of school composition to be produced. The graphical user interface 20 also provides point-and-click access to a Tool Palette 30, Message Console 32, Tag Palette 34, and Global properties 36 and Local Properties 37 as shown in FIGS. 2-6.

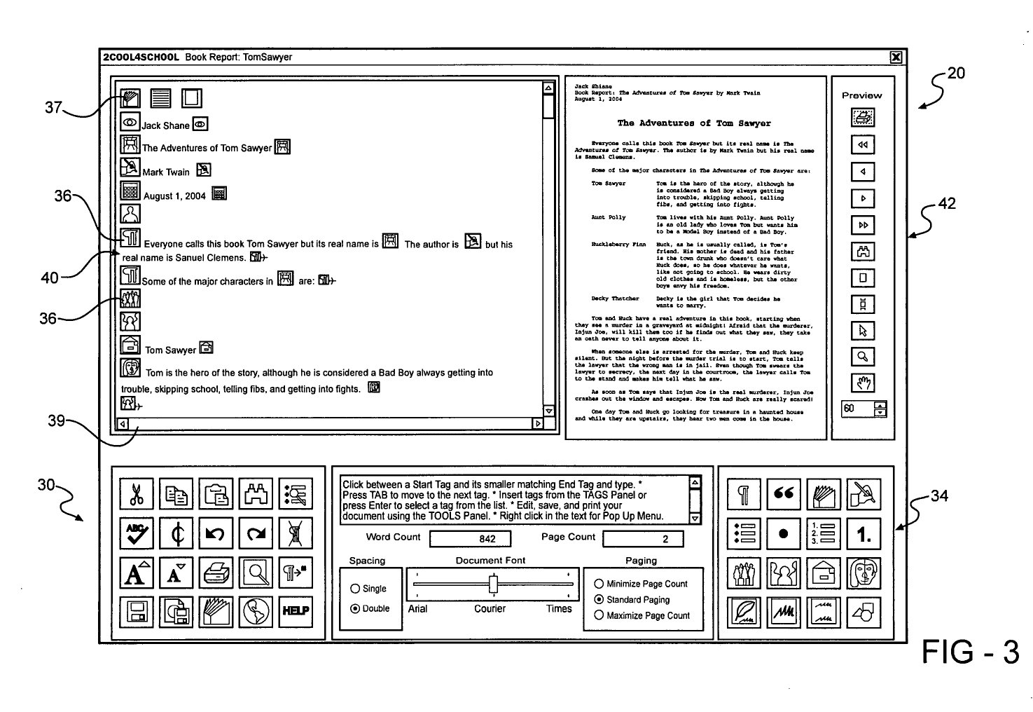

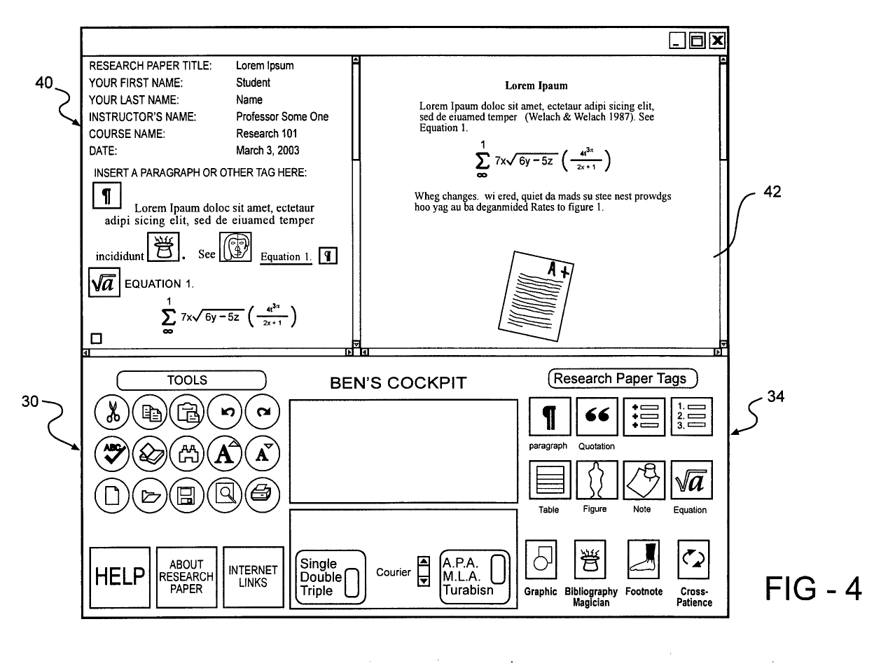

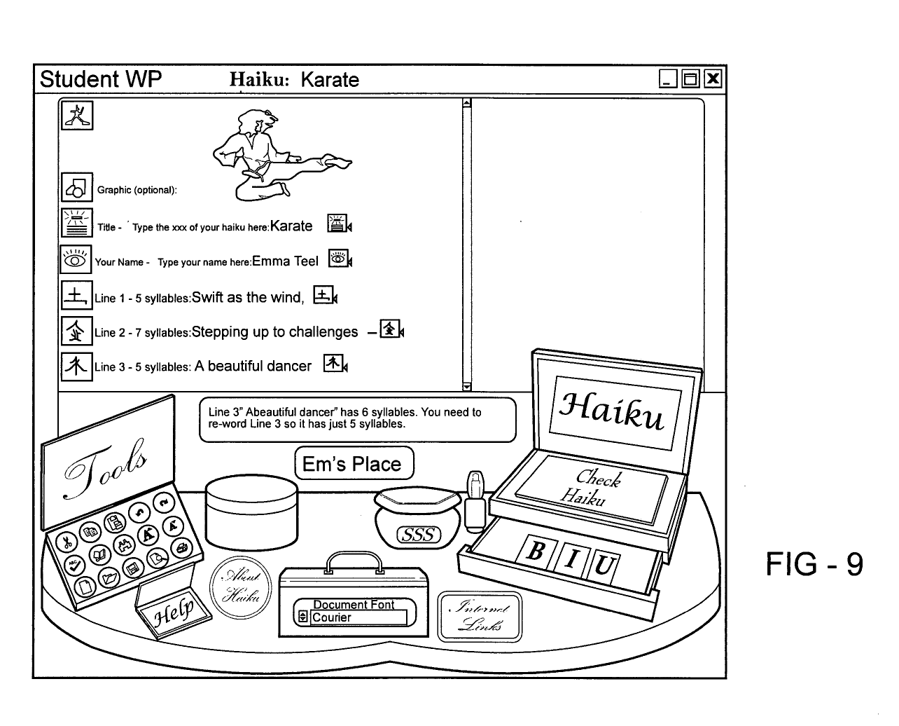

Each type of school composition is an SGML/XML Document Type named for the type of composition and consisting of a Document Type Definition (DTD) file, stylesheets files, and other electronic files and scripts necessary to create and customize the Document Type. The Document Types include but are not limited to: Haiku, FIG. 9, Book Report, FIG. 3, Research Paper, FIG. 4, Term Paper, Essay, Lab Report, Short Story, School Play, Sonnet, Limerick.

A structured document is created, added to, and changed according to the framework defined in the Document Type DTD.

The new or existing document is displayed in the Edit Window 40, FIG. 3, portion of the user-selected graphical user interface. In the displayed structured document, iconic pictures (“tags”) represent SGML/SML elements. The first tag in the document represents the Document Type.

Within the Edit Window, the program supports the authoring and editing tasks of typing, backspacing, deleting, moving, copying, pasting, spell checking, etc. The graphical user interface 20 provides point-and-click access to file-related and editing-related operations.

The graphical user interface 20 also displays a palette of the tags 34 that can be inserted into the structured document. The allowable tags 34 depend on the type of school composition to be produced. For example, the tags 34 for a haiku poem are not the same as the tags 34 for a Book Report, and the Equation tag 34 that is allowed in a Research Paper is not available in a Sonnet.

Within a structured document, the allowable tags 34 may change depending on the location of the cursor in the document. For example, if the cursor is located in the body of a Book Report Document, available tags 34 include paragraphs and lists, neither of which is available when the cursor is located in the title of the Book Report.

This context-sensitivity ensures that the structured document is always properly structured according to the Document Type Definition for that type of school composition. Similarly, although tags as well as text can be cut and copied, tags 34 that are required for the document structure are not allowed to be deleted and tags 34 are not allowed to be pasted in a location that would violate the document structure. Whenever possible, the program transforms the disallowed tag into an allowed tag.

To insert an available tag, the user clicks on it in the Tag Palette 34 and begins typing. Alternatively, the user can begin typing anywhere a paragraph is allowed and a paragraph tag 34 will be automatically inserted around the typed text.

At any time, the structured document displayed in the Edit Window 40 can be previewed so its print image is displayed in the side-by-side Preview Window 42 that is also part of the graphical user interface. The user can click on text in the Preview Window 42 and be linked to the location of that text in the Edit Window 40.

Formatting is linked to the tags 34 in the structured document but is stored separately from the document text, which enables the document to be instantly formatted into a variety of presentation styles. Default presentation styles can be used to produce a correctly formatted school composition in minimum time.

Formatting can be changed at any time by choosing a different predefined presentation style and/or modifying the Properties (SGML/XML attributes) associated with each tag 34 by simply double-clicking on the tag in the Edit Window 40 to display a dialog for viewing and changing Properties. There is no need to select text or tags in the Edit Window 40 to change formatting properties.

The tag 34 representing the Document Type has properties that affect the entire document (Global Properties 37) while the properties for other tags affect only the text inside those tags (Local Properties 36).

Global Properties 37 include the language of the document, paper size, font color, background color, background image. Global Properties 37 also include a variety of predefined styles each with its own font(s), color scheme, and layout designed to facilitate and enhance readers' perception of the document contents. The Global Properties 37 associated with a Document Type tag depend on what is suitable for that Document Type. Citation Style is a Global Property in the Research Paper Document Type that is not available in the Haiku Document Type.

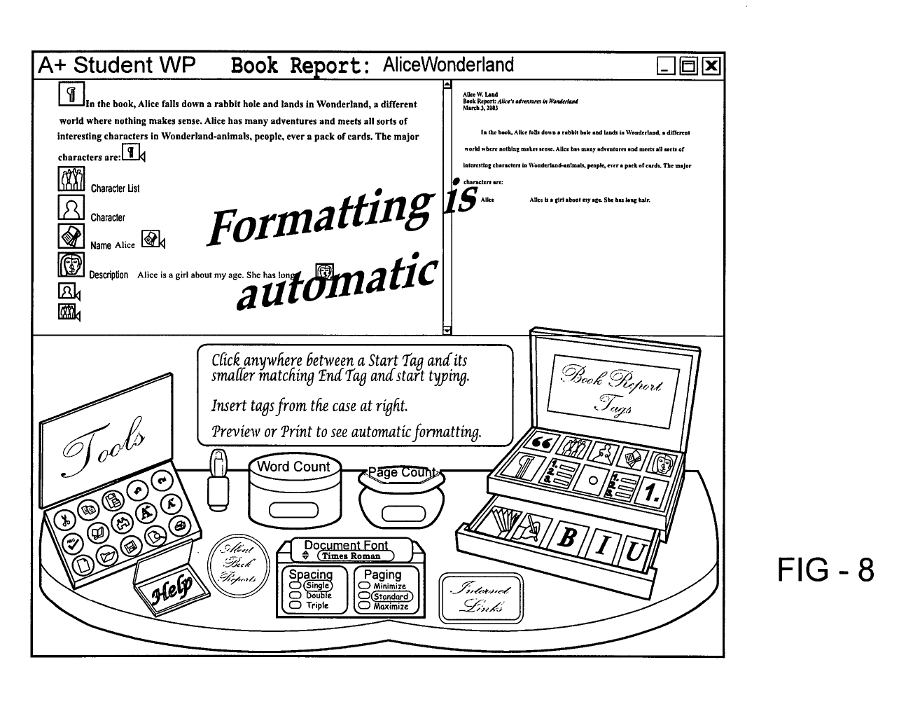

One or more frequently used Global Properties 37, such as Document Font, is displayed directly in the graphical user interface, see FIGS. 3, 4, 6, 8, and 9, in a way that users can manipulate with a mouse to select the desired setting.

Some Global Properties 37 are available as Local Properties 36 on non-Document Type tags to override the properties set on the Document Tag. For example, the Global Properties 37 may specify the bullet list style for the entire document, but if a different style is desired for a particular bullet list, its Local Properties 37 can be set to override the Global Properties 37. Global 37 and Local Properties 36 can be used together as desired to craft custom presentation styles for the document.

To access Global and Local Properties, the user double clicks on the icon 39 in FIG. 3 after a tag, or clicks once after the tag 34 then clicks on the icon 39.

Structured documents produced with the program can be previewed 44, FIG. 1, printed 46 to paper or electronic file, and saved as HTML 48 with formatting based on the printed image.

The contents of the Edit Window 40 can be printed with or without tags.

Tools are provided for each Document Type whose purpose is to validate structured student documents against the rules for the type of composition. For example, the Haiku Document Type has a tool to check the syllable count for each line of the Haiku poem and report lines with the incorrect number of syllables.

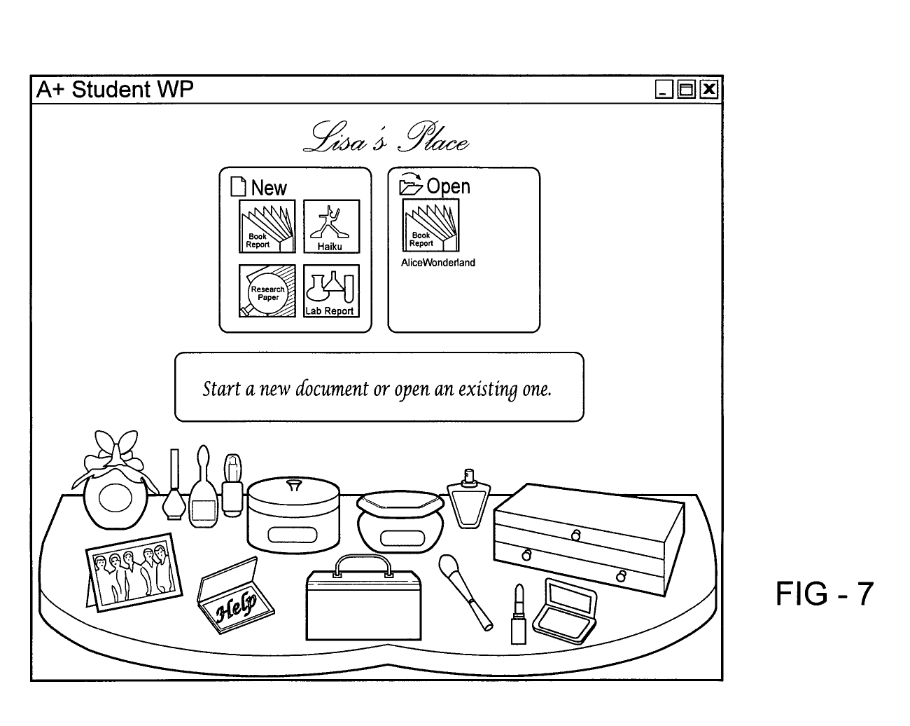

FIGS. 7-9 depict a different graphical user interface 20 suited, by example, for a female. The same Tool Palette 30, Message Console 32, Tag Palette 34 are employed and presented for selection by the user.

The following example of a Research Paper Document, FIG. 4, illustrates how the program works.

The Research Paper Document Type will automatically format the paper according to the citation style chosen by the student. The student just needs to type inside the appropriate tags. The software will do the rest as described below.

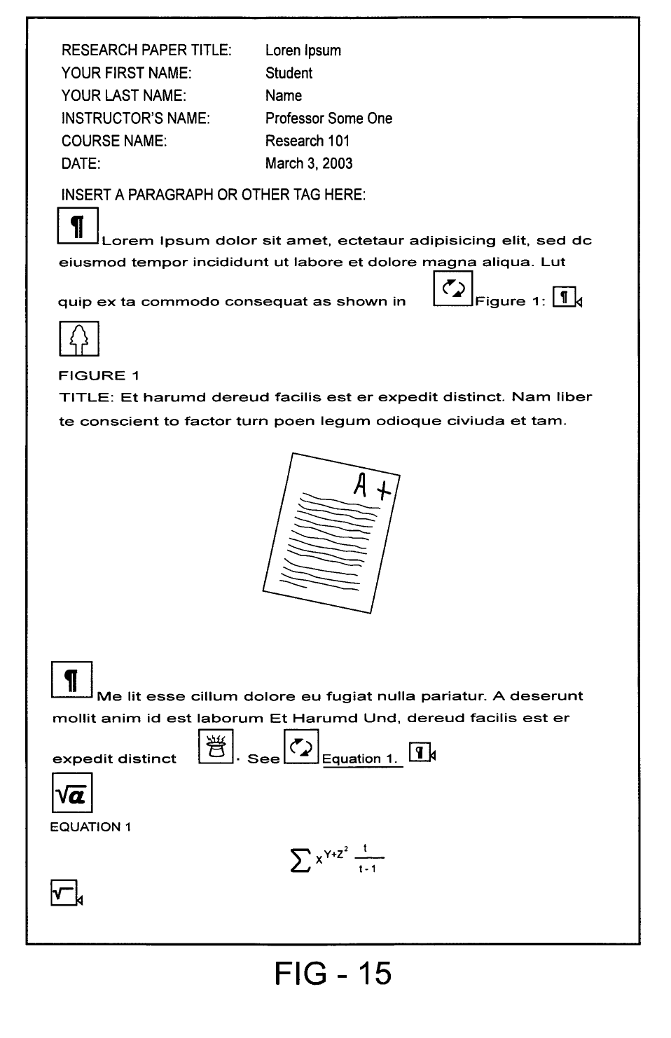

In the graphic shown in FIG. 15, which shows the beginning of a Research paper Document, the Paragraph, Figure and Equation tags are “double tags” with a “start tag” and a smaller matching “end tag.” Double tags and single tags use different color schemes so it is easy to tell them apart. The user types in between double tags.

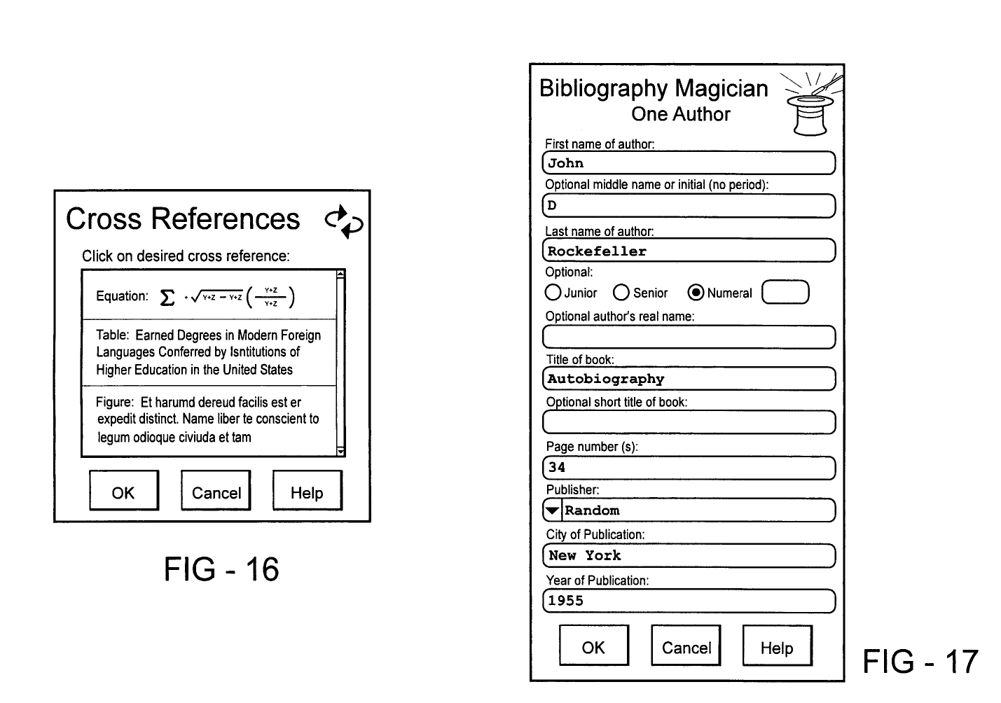

The Cross Reference, Bibliography Magician and Graphic tags are “single tags.” Only one tag is needed because it opens a dialog. A sample dialog is shown in FIG. 16 for the Cross Reference tag.

When students want to include a citation in the text of their papers, they will insert the Bibliography Magician tag, the Research Paper Document's most powerful tag. FIG. 17 shows how students will enter only the raw information about the source they are citing into a dialog box.

The program will do the rest, providing the spacing, punctuation, abbreviations, underlining and anything else required for the chosen citation style. For example, the following graphic shows how the citation information entered the Bibliography Magician dialog above will be formatted when MLA style is selected:
cupy uf cak vux noaw yerw phuno (Rockefeller 34).

When APA style is chosen, the citation will be formatted as shown in the graphic below:
cupy uf cak vux noaw yerw phuno (Rockefeller 1955).

In addition to inserting the citation in the text, the invention generates the list of works cited in the paper. For example, the citation below shows the Rockefeller entry when MLA style is selected:

Rockefeller, John D. IV. (1955) Autobiography. New York: Random.

The following citation shows the same entry in APA style:

Rockefeller, J. D., IV (1955) Autobiography. New York: Random.

The program will also provide the correct title for the list of works cited. When the chosen citation style is MLA or Chicago/Turabian, “Works Cited” will be inserted; when APA style is selected, “References” will be generated.

In addition, when Chicago/Turabian style is chosen, the program will generate a title page, table of contents, list of figures and list of tables. Also, an abstract will be required and a dedication will be allowed. If the student changes the citation style from Chicago/Turabian style to MLA or APA, the title page, table of contents, list of figures, list of tables, abstract and dedication will not appear in the preview or printout.

Students naturally want to re-purpose their research papers when possible. The program will make it easy. Students will be able to:
copy citations from existing Research Paper Documents and paste them in new Research Paper Documents without concern for the citation style. The invention will format the new paper according to the selected citation style; and/or
change from one citation style to a second to a third, and back again, with a click of the mouse. The invention will automatically re-format the citations and the list of references/works cited using whatever spacing, punctuation and formatting are appropriate for the selected citation style.

All Research Paper Document formatting is completely automatic. The program will:
format text according to its tag 34, including automatic numbering of lists, outlines, footnotes, table, equations and figures;
insert cross reference text;
format footnotes and end notes;
include the appropriate page headers, footers and numbering;
insert citation information in the text in accordance with the chosen citation style;
generate the list of references/works cited with the title required by the citation style;
generate a title page, table of contents, list of tables, and list of figures when appropriate for the citation style; and/or
generate an index if desired.

The Research Paper Document will include features such as:
a WYSIWYG Table Designer that enables students to easily create, edit and format tables as well as copy tables from Microsoft Excel;
a WYSIWYG Equation Creator that enables students to easily create, edit and format complex equations;
a Document Map feature to enable users to easily navigate long documents; and/or
excerpts from supported citation style guides as electronic files that students can search to quickly locate the information they need.

The program is an application of Arbortext's Epic Editor™ software that is implemented by accomplishing tasks including, but not limited to, the following:
providing the following application programs for each type of student composition to be supported in the product. Together these electronic files comprise an SGML/XML Document Type.

Document Type Definition (DTD) including the screen display formatting in the Edit Window which defines the structure of the Document Type; for example haiku.dtd.

Format Output Specification Instance (FOSI) which specifies the formatting for documents authored according to the structure defined in the DTD including the screen display formatting in the Edit Window; for example, haiku.fos.

Document Type Configuration File (DCF) which customizes the Document Type within Epic Editor; for example haiku.dcf.

An SGML/XML sample document for each Document Type; for example, haiku.xml.

An SGML/XML Catalog electronic file that includes the SGML/XML Public Identifier for each Document Type and its location in the electronic file system to enable Epic Editor to find the relevant files for each Document Type.

Programs and scripts in Arbortext Command Language (ACL), XML-based User Interface (XUI), Java, and/or other application programming languages to:
display the graphical user interfaces;
activate the buttons, controls, and tools in the graphical user interfaces;
provide functionality for tools and features;
provide software programs, scripts, databases, and other electronic files and use ACL, Java, and/or other application programming languages to integrate them into Epic Editor as described in Epic Editor documentation to support product features such as hyphenation, syllable counting, rhyme checking, and verbal proofreading:
specialty dictionaries (medical, legal, etc.);
Syllabic dictionaries;
rhyme databases;
text-to-speech technology;
provide access from within the product to online databases such as ISBN/ISSN information and develop ACL, Java, or other programs and/or scripts to automatically populate elements and attributes in a Research paper Document with information from the database;
provide product help information including, but not limited to, the following tasks and deploy in the program as HTML online help according to Epic Editor documentation;
information about how to use, and when applicable how to personalize all product features;
interactive tutorials on how to use, and when applicable how to personalize all product features;
educational information about student documents to be written by subject matter experts;
a list of Internet links to sites related to student documents to be compiled by subject matter experts; and
reproduction of excerpts from citation style guides and other reference materials as part of product online help information;
Given the ingenuity of some young people, unused Epic Editor functionality could be disabled so it is not possible for users to access more than they purchased.

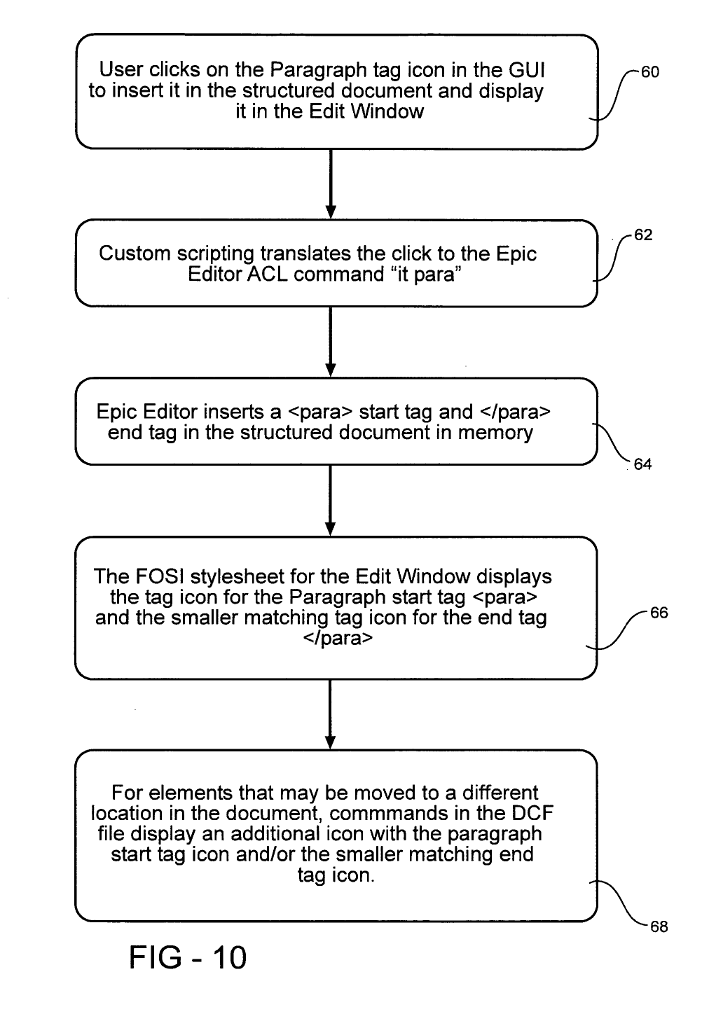

FIG. 10 is a flowchart showing how a student clicks on the Paragraph tag (A) in the Tag Palette (34), step 60. Custom scripting translates the click into the Epic Editor ACL command “it para”, step 62, which inserts a Paragraph tag at the next place it is allowed in the structured document as dictated by the Document Type Definition (DTD), step 64. The FOSI stylesheet then causes the tag to be displayed as a graphic icon for the first tag in the tag pair (Start Tag) and a smaller matching graphic icon for the second tag in the tag pair (End Tag) (B), step 66. For tags or elements that are allowed by the DTD to be moved to different locations in the document, settings in the DCF configuration file cause an additional icon to be displayed with the Paragraph Start Tag and/or End Tag icon, step 68.

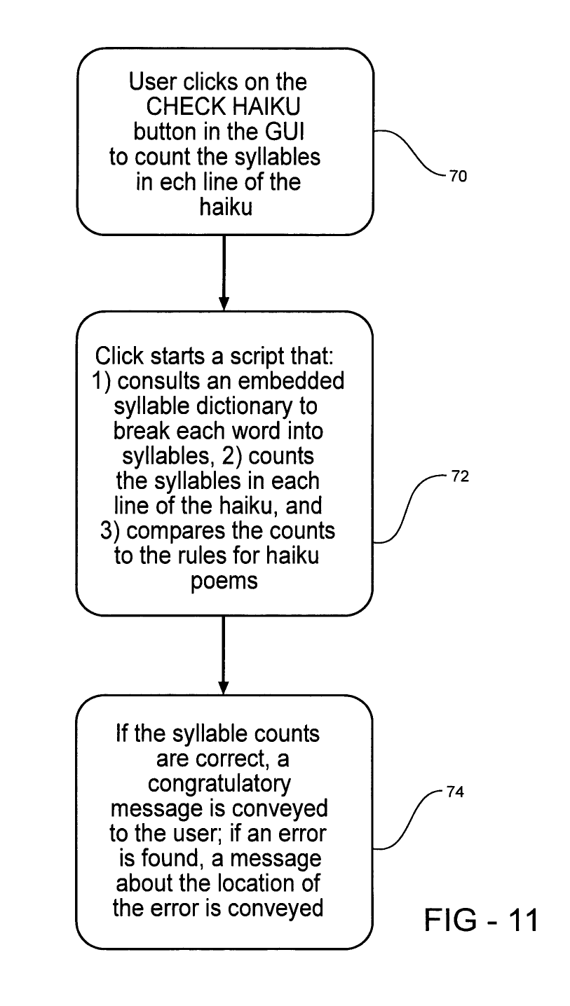

FIG. 11 is a flowchart showing in steps 70, 72 and 74, how the Check Haiku tool (C) available with the Haiku Document Type is activated by the student to count the syllables in each line of the haiku poem. check them against the number of syllables that should be included in each of the three lines of a haiku poem, and report the results to the student in the Message Window (D).

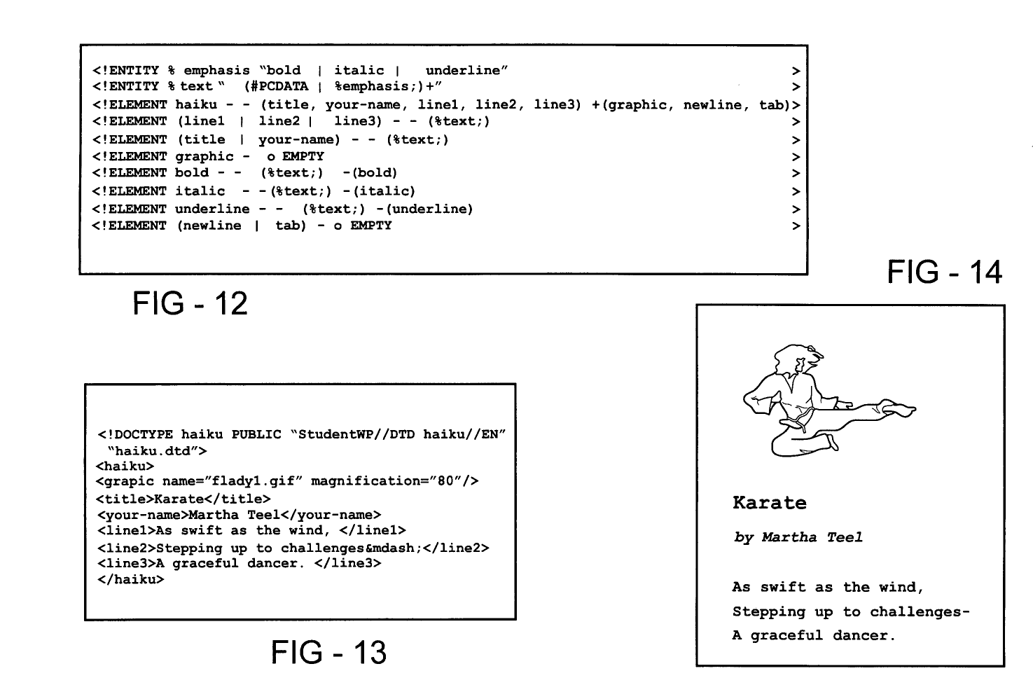

FIG. 12 shows part of the XML DTD that defines the Haiku Document Type's structure and the elements (“tags”) allowed, specifically: the singleton tags Graphic, Bold, Italic, Underline, Newline, and Tab, and the tag pairs Haiku, Title, Your-Name, Line1, Line2, and Line3.

FIG. 13 shows an XML document instance that uses the following tags: Haiku, Graphic, Title, Your-Name, Line1, Line2, and Line3. It includes only text and tags. Specifically, no formatting information is included.

FIG. 14 shows one of the ways the document instance in FIG. 13 can be formatted for print. The formatting for each tag is stored in a separate file and applied to the document shown in FIG. 13 when it is previewed or printed. The formatting is never stored with the text and tags as shown in FIG. 13 which means any number of stylesheets can be applied to the structured document to produce different formatted output.

Many additional features can be provided as described below.

Additional Graphical User Interfaces:

additional graphical user interfaces can be added, including new themes, and color combinations.

Additional Citation Styles:

Both MLA and Turabian/Chicago styles include alternate formats that can be added to the Research Paper Document:
MLA Style includes Works Cited at the end of a paper to provide reference information. An earlier style, now going out of date, is to use footnotes. This style can be supported in the Research Paper if absolutely necessary. Footnote formatting in Epic has limitations; and
Turabian/Chicago style has an alternate citation style that numbers each citation and lists the numbered references at the end of the paper. The citation in text is a number in square brackets. This citation style can be supported in the Research Paper.

Support can also be added for other popular citation styles required by colleges/universities and academic associations and journals. For example:
Harvard Style, required at Harvard and other colleges and universities;
Yale Style, required at Yale and other colleges and universities;
CBE (Council of Biology Editors) Style, used by writers in the applied sciences and the medical sciences; and
MHRA (Modern Humanities Research Association) Style, required by some humanities journals.

Two additional variations of the author-date style in brackets (2]) are popular and can be supported. These styles are used in some computer-related journals.

Some of the many other citation styles used by various disciplines are listed below:
Chemistry—The ACS Style Guide: A Manual for Authors and Editors;
Engineering—“ASCE On-Line Authors' Guide”; Institute of Electrical and Electronics Engineers. Information for IEEE Transactions and Journal Authors;
Geology—Geowriting: A Guide to Writing, Editing, and Printing in Earth Science;
Government—The Complete Guide to Citing Government Information Resources: A Manual for Writers and Librarians;
Journalism—Associated Press Stylebook and Libel Manual;
Law—The Bluebook: A Uniform System of Citation; Citing and Typing the Law: A Guide to Legal Citation and Style;
Linguistics—LSA Style Sheet;
Mathematics—Mathematics into Type;
Medicine—American Medical Association Manual of Style;
Music—Writing About Music: A Style Sheet from the Editors of Nineteenth-Century Music;
Physics—AIP Style Manual;
Political Science—Political Science Student Writer's Manual; Style Manual for Political Science; and
Sciences—American National Standard for the Preparation of Scientific Papers for Written or Oral Presentation.
   Additional Bibliography Magician Features:

In the College/University Edition, additional bibliography features can be provided in the Research Paper Document. For example:

A “no-tags” view of the document could be selected for easy onscreen reading, using icons to represent citations in text. Double-clicking on an icon would display the citation.

A “draft” of the list of references/works cited could be generated without printing the entire document.
The list of references/works cited could be displayed in a separate window side by side with the Editor Window so the user could double-click on each item in the list of references/works cited in the separate window and be taken to the location of the text citation in the Editor Window.

The program could generate an electronic file with all the unique citations in all SGML/XML documents in the directories specified by the user and provide an interface that lets the user easily insert existing citations in new documents.

Additional Document Types:

Support for other types of documents to be determined can be added to the product, as discussed below.

School-Related Documents:

Examples of school-related documents that could be supported include:
Club Newsletter; Literary Magazine; School Newspaper; Student Web site; and Yearbook.
   Personal Correspondence Document Types:

Personal Correspondence Document Types could also be supported, for example:
Thank-You Letter; Letter to a Friend; Letter to a Relative; Holiday Gift List; Party Invitation; and Greeting Card.
   Email Document:

An Email Document (HTML document type) could be added to enable students to author email using their favorite invention graphic user interface.

A personal journal/web log Document Type can be added to enable students to author a personal journal/web log using their favorite invention graphic user interface.

Additional Educational Content:

More educational content can be added:

Users could choose a “Flash Card” feature to display a new “tip” or “hint” every time they start up the invention. Users could choose the subject matter: capitalization, grammar, punctuation, spelling, etc. Students who consider the subject matter unpleasant may find it more palatable in small bites.

For daily vocabulary building, Merriam-Webster's Word of the Day at http://www.m-w.com/cgi-bin/mwwod.pl which features a new vocabulary word every day, could be displayed in a browser whenever the student starts the invention.

Additional Tools:

New tools and features can be added, depending on the Document. For example:

A Rhyme Minder can be added to Poetry Documents to check the rhymes in poems and to suggest rhyming possibilities.

A Proof Reader tool could be added to read the paper aloud (using text-to-speech technology) while the student follows the text onscreen or in a printout.

Depending on the capabilities of text-to-speech technology, a School Play could be read aloud using different voices for the different roles as selected by the user. This is possible because in the invention School Play Document, th eroles, stage directions, acts, scenes, etc. will be identified by tags.

A document differencing feature can be added to the College/University Edition, using Epic Editor's Compare.

Additional Reference Materials:

Other reference materials can be added to the online Help for the Research Paper Document. For example, excerpts from handbooks on research and statistical methods could be included. As new citation styles are added, reference materials for the newly supported academic disciplines can be added.

Additional Languages:

Epic Editor supports many languages, as shown in the following list:
1. Catalan
2. Chinese (simplified)
3. Chinese (traditional)
4. Czech
5. Danish
6. Dutch
7. English (UK)
8. English (US)
9. Finnish
10. French
11. French (Canadian)
12. German
13. Greek
14. Italian
15. Japanese
16. Korean
17. New Norwegian (Nynorsk)
18. Norwegian (Bokmål)
19. Polish
20. Portugese
21. Portugese (Brazilian)
22. Russian
23. Spanish
24. Swedish
25. Swiss German

The program can be made available in these languages and marketed throughout the world.

Additional Links to Internet Resources:

Links to Internet resources such as the WordNet Dictionary can be added.

Hyperlinks:

A tag can be added to the Document Types that would treat the text in the tag as a URL. Students could include URLs in their papers so that teachers could review the papers in the invention and link to the Internet sites to quickly verify references to online sources.

ISBN/ISSN-Based Citations:

ISBN and ISSN numbers are used to identify most books and serials. It may be feasible to support an online feature that allows users to type in an ISBN or ISSN number that the Bibliography Magician would decode into text surrounded by the appropriate tags. Users would have to enter the specific page number(s) referenced. Bowker maintains the ISBN database and publishes it as Books in Print which can be accessed via Bowker's online service.

Text Macros:

Epic Editor supports SGML/XML text entities which allow the user to define a text string as a macro. To change every occurrence of the string, only the macro definition must be changed.

Abbreviation/Acronym Wizard:

A Wizard could be provided to properly handle abbreviations and acronyms. Abbreviations and acronyms can be presented in one of two styles, depending on the academic discipline:

1. For the first occurrence, the spelled out term is followed by the abbreviation or acronym in parentheses; for example, “Modern Language Association (MLA).” For subsequent occurrences, just the abbreviation/acronym is used.

2. For the first occurrence, the abbreviation/acronym is followed by the spelled out term in parentheses; for example, “ICs (integrated circuits).” After that, just the abbreviation/acronym is used.

One or more tags for abbreviations/acronyms can be added to appropriate Document Types. When the first abbreviation/acronym tag is inserted, the user would be asked to supply the abbreviation/acronym and the complete term. Then the tag can be inserted, copied, cut, pasted, deleted and moved around without regard for what comes first. When the Document is previewed and printed, the abbreviation/acronym will be correctly presented according to the style selected by the user.

Auto Outline:

A feature could be added to automatically create a dynamic outline of a Document from the title tags for divisions such as chapters, sections, subsections, etc. When the text in a title tag changes, the next preview or print would show the updated outline with the new title text.

Auto Summary:

An auto summary feature could be added. Artificial intelligence for automatic summarization could be combined with the real intelligence provided by SGML/XML tags to create a better auto summary than what is available with existing word processors.

Main/Sub Documents;

Epic Editor supports SGML/XML file entities which allow the user to easily create a main document that references subdocuments. This feature is useful for long documents, such as theses and dissertations.

Change Bars:

A change bars feature can be added to the College/University Edition of the invention. Dissertation committees, for example, would find change bars useful.

Epic Editor already supports change bars. Change markup can be tag pairs or singleton tags that can straddle block elements. Multiple levels of change bars can be supported.

In the Editor Window, added text can be shown in color, underlined or presented with other formatting that appears only in the Editor Window, not in preview or print.

In the Editor Window, text in <delete> tags can be collapsed and its presence indicated by a graphic. Text that is deleted can also be displayed with specific formatting in the Editor Window, but neither the text nor formatting will appear in preview or print. It may be possible to use the Docmap view to display only those lines with deleted text.

TEX Tags:

Epic Editor can interpret TEX coding, so the Research Paper Document in the College/University Edition of the invention can be enhanced by the addition of one or more “TEX tags” for users to enter TEX coding directly. This would allow the user to copy complex equation coding from an existing TEX document and paste it into a Research Paper Document without using Easy Equations. When the user previews or prints the document, the equation appears in the same format as in the TEX document.

Note that TEX tags are needed in order to import LaTex files with equations. Refer to Import/Export Documents, below.

Import/Export Documents:

In addition to the Save As Web Page feature, various import/export features are possible:

Framemaker, Interleaf, Word. Epic Editor currently supports import from Interleaf and import/export from/to Word and Framemaker. This capability can be added once the necessary configuration files are developed for each document.

Other SGML/XML. Import of SGML/XML files from other products such as WordPerfect can be supported.

Import/Export of TEX/LaTex files from/to Research Paper Documents can be developed for the College/University Edition. One or more TEX tags (see TEX tags) is required to handle import of equations.

HTML. HTML documents can be imported and automatically formatted using one of the pre-defined formats selected by the student. Note that these formats would be optimized for paper output, using formatting that is not available with CSS and producing fewer pages than printing from a browser. Additional pre-defined formats for HTML can be added over time.

ASCII. The HTML file generated by File→Save As Web Page can be stripped of HTML markup to create an ASCII version of a Document that includes generated numbering, symbols and text, but no formatting except spaces and line breaks. Note that symbols would be limited to ASCII or extended ASCII characters. Simple tables would be formatted using spaces and line breaks, but complex tables would be problematic. Graphics would appear as “Graphic Name Here.” It may be possible to convert simple equations into properly formatted ASCII text. Complex equations would appear as “Equation Number Here.”

Specific Page Count:

ACL and FOSI coding can be combined to format documents such as Book Report and Term Paper to fit the number of pages specified by the user.

Save As SGML/XML:

Epic Editor supports Save As SGML/XML to save SGML as XML and vice versa. This capability can easily be provided.

Include/Exclude Sections:

Epic Editor supports SGML marked sections which identify text to be included in or excluded from preview and print. This functionality could be added to the Research Paper Document.

Output to PDF:

If Acrobat Distiller is installed, Epic Editor supports output to PDF, including PDF and URL links. This feature can easily be enabled.

Student Document Tracking:

The program could provide a document tracking feature designed especially for students. For example: File→Track Documents, File→Close and File→Exit could provide an interface to track documents worked on in that session. Students could:
designate each document as “final” or “draft” with a draft number and/or date;
establish due dates for draft and final versions;
designate a document as “submitted” and record the date of submission;
enter the grade received on each paper; the invention could respond with grade-specific spoken messages (for example, entering an “A” could cause the software to respond with “Congratulations!”); and
enter any notes about the paper, for example, if it contains a frequently used citation that could be copied and pasted into a future paper.

Each draft and final version could be uniquely named and saved in a separate archive directory so that any particular version could be easily restored at any time.

Document tracking would have different functionality and styling for the College Prep Edition and the College/University Edition. In both editions, this feature could be turned on and off at the Preferences level.

Homework Joke of the Day:

Students could set Preferences to see or hear a new joke about homework whenever they start the software. Users would provide the content by submitting their jokes on the Web site. Those who submit jokes could feel particularly motivated to upgrade to each new release so they could see if their submissions were approved for inclusion in the product.

Bibliography Database

For serious researchers, a bibliography database feature could be added to the College/University Edition that would enable students to copy citation information from a web site and “paste” it in a database. The database would include links to web sites so citations can be verified at a later date. Students would also be able to enter information directly into the database. Users would be able to click on citations in the database and have them automatically inserted in the proper tags in a Research Paper document.

Database searching and reporting features could also be provided.

Table Templates:

Pre-formatted templates for table layouts used in various scholarly disciplines.

Commenting Feature:

A commenting feature that enables students to add comments in the document such as “Verify this quotation” that can be toggled on and off in the screen display and draft prints but will not appear in final printouts. A report can be generated that lists all comments in the document.

Editorial Assistant:

An Editorial Assistant feature will provide useful information regarding conventions used in the various Document Types. For example, in Document Types such as Essay and Research Paper, abbreviations such as “i.e.” will be detected real-time or during a batch Check Document process. A dialog will:
alert the user to the meaning and correct usage of it and similar abbreviations such as “e.g.”;
advise when the spelled&ndash;out phrase is preferred to an abbreviation; and
enable insertion of the correct form of the desired abbreviation or phrase.

Preferences settings will control this feature.

Clip Art Organizer:

A clip art organizer with a library of graphics pertinent to student documents should be added to the product to increase its user-friendliness. Each new release of the software would include new graphics.

Spoken Messages:

The product could support spoken messages in addition to displayed messages. Spoken messages seem especially appropriate for younger users.

Hands-Free Operation:

Arbortext's Epic Editor currently responds to some spoken commands using a speech recognition software product. As speech recognition technology improves, a hands-free version could be pursued to widen accessibility. Spoken commands seem natural with the invention's menu-free graphical user interface.

Touch-Screen Operation:

To widen accessibility, touch-screen operation will be investigated as a potential replacement/supplement for a mouse device. The invention's menu-free graphical user interface is especially well-suited to touch-screen operation, especially compared with traditional menu-based products such as Microsoft Word.

Field of Study Editions:

Editions can be packaged according to the field of study. For example, the following editions could be created with the appropriate electronic reference materials and links:
Medical Edition with a medical spelling dictionary; and
Legal Edition with a legal spelling dictionary.
   Early Grades Edition:

An edition for younger children could also be provided.

Citation Editions:

Some college/university students need only Turabian/Chicago style, some need both MLA and APA while others need Turabian/Chicago, MHRA, and MLA. New editions can be created by packaging together related citation styles and pricing them accordingly. One possibility is a Humanities Edition with Turabian/Chicago, MHRA, and MLA.

Language Editions:

Multilingual editions can be created for different regions of the world, for example:
Canadian Edition—English/French
Asian Edition—Chinese/Japanese/Korean
   Companion Products:

Companion products that are SGML/XML-based can be developed to complement the invention. Students deserve software that meets their special needs. SGML/XML technology enables seamless sharing of the same tagged information.

Student Calendar:

An online Calendar feature based on a school year with semesters, semester breaks, etc., could be provided to enable students to easily plan and schedule their time. University-specific editions could easily be developed.

Desktop Suite:

A Desktop Suite can be provided so users do not need MICROSOFT Office or its components. A Desktop Suite would minimally include presentation and spreadsheet software in addition to the word processor and above-described Student Calendar.

For example, a title, paragraph and bullet-list (tags and text) could be copied from a word processing Document and pasted into a presentation. In the presentation, the pasted text would be formatted according to the stylesheet in effect. As with the word processor, the formatting for a presentation could be changed at any time simply by selecting a different stylesheet.

The word processor and presentation software could be combined into one product sharing the same .SGM/.XML files without the need for importing or conversion. New Document Types for correspondence, professional reports, etc., are also possibilities so users do not need any other word processor software.

1. A document production method for producing student compositions that are structured according to predefined Document Types, the method includes at least one or more of the following process steps or elements:
selecting graphical user interfaces for authoring, editing, and formatting structured documents;
automatic formatting and reformatting of structured student documents including system-generated material; and generating the document;

2. The method of claim 1 further comprising the step of:
providing the graphical user interfaces as user personalizable graphical user interfaces.

3. The method of claim 1 wherein the step of selecting graphical user interfaces further comprises the step of:
in the graphical user interfaces, displaying SGML/XML tags as graphics.

4. The method of claim 1 wherein the step of selecting graphical user interfaces further comprises the step of:
displaying “tagged” documents in an edit window adjacent to a formatted version of the document in the preview window.

5. The method of claim 1 wherein the step of selecting graphical user interfaces further comprises the step of:
displaying available features and tools graphically for selection.

6. The method of claim 1 further comprising the step of:
providing an equation creator for authoring equations in an WYSIWYG environment.

7. The method of claim 1 wherein the provision of system generated material for the automatic formatting and reformatting of structured documents comprises the step of:
providing text, numbering, graphics, symbols, spacing, punctuation, table of contents, list of tables, list of illustrations, citations, bibliography, list of references, list of works cited, and an index as appropriate for the type and style of student composition.

8. The method of claim 1 further comprising the step of:
providing a variety of predefined, user-selectable presentation formats for each type of structured document.

9. The method of claim 1 further comprising the step of:
providing global properties users for modifying predefined document presentation files.

10. The method of claim 9 further comprising the step of:
providing the global properties as modifiable global properties.

11. The method of claim 1 further comprising the step of:
providing tags for formatting each different document type; and
providing local properties to customize formatting associated with each tag.

12. The method of claim 11 further wherein the step of providing local properties further comprises the step of:
providing modifiable local properties.

13. The method of claim 1 further comprising the step of:
providing tools to validate structured documents against predefined rules for the type of document.

14. The method of claim 1 further comprising the step of:
providing a link to educational information relating to student compositions.

15. The method of claim 1 further comprising the step of:
providing a link approved to internet sites providing information relating to student compositions.

16. The method of claim 1 wherein the step of generating the document further comprises the step of:
providing the document as one of a printed document and an electronic file.

17. The method of claim 1 wherein the step of generating the document further comprises the step of:
converting the document to HTML for display in a browser.

18. The method of claim 1 further comprising the step of:
providing a link to online product help information.

19. The method of claim 1 further comprising the step of:
providing a table designer for authoring custom tables that are structured as SGML or XML.
